(19) United States
(12) Patent Application Publication
(10) Pub. No.: US 2007/0295188 A1
(43) Pub. Date: Dec. 27, 2007

(54) Method for making plane animated printed drawings on a drumhead

(76) Inventor: Shih-Ying Lu, Dali City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/473,233

(22) Filed: Jun. 23, 2006

(51) Int. Cl. G10D 13/02

(52) U.S. Cl. 84/411 R

(57) ABSTRACT

A drumhead has several grating furrows and veins formed on an upper surface of a base material thereof, and continuous drawings printed on a lower surface of the base material; the continuous drawings are printed by means of plane printing; therefore, when the drumhead is hit and vibrating, the grating furrows and veins will refract light such that the continuous printed drawings show on the drumhead in an animated manner.

### BACKGROUND OF THE INVENTION

1. Field of the Invention

The present invention relates to a drumhead, more particularly one, which has several grating furrows and veins formed on an upper surface of a base material thereof, and continuous drawings printed on a lower surface of the base material; thus, when the drumhead is hit and vibrating, the continuous printed drawings will show on the drumhead in an animated manner.

2. Brief Description of the Prior Art

There are five major kinds of percussion instruments, drums, gongs, cymbals, castanets, and bells, which can be made of metals, bamboos, wood, and leather.

A conventional drum includes a hollow drum body, two heads secured over respective ones of two ends of the hollow drum body, and several tension rods positioned around the hollow drum body, which are used for adjusting tension of the heads so as to control sound produced by the drum.

However, common drumheads are usually made of either leather or plastic materials, and are usually either transparent or white colored, having relatively monotonous appearance. Consequently, current existing drumheads aren't attractive.

### SUMMARY OF THE INVENTION

It is a main object of the invention to provide an improvement on a method for making a drumhead to overcome the above-mentioned problems. The method of the present invention includes the following steps: forming grating furrows and veins on an upper surface of a base material of a drumhead, and printing continuous drawings on a lower surface of the base material of the drumhead; the grating furrows and veins are formed by means of a roller; the continuous drawings are printed by means of plane printing with a mesh-printing machine. Therefore, when the drumhead is struck and vibrating, the grating furrows and veins will refract light such that the continuous printed drawings show on the drumhead in an animated manner.

### BRIEF DESCRIPTION OF THE DRAWINGS

The present invention will be better understood by referring to the accompanying drawings, wherein:

FIG. 1 is a perspective view of a drum in the present invention,

FIG. 2 is a view of an animated printed drawing in the present invention, and

FIG. 3 is a sectional view of the present invention.

### DETAILED DESCRIPTION OF THE PREFERRED EMBODIMENTS

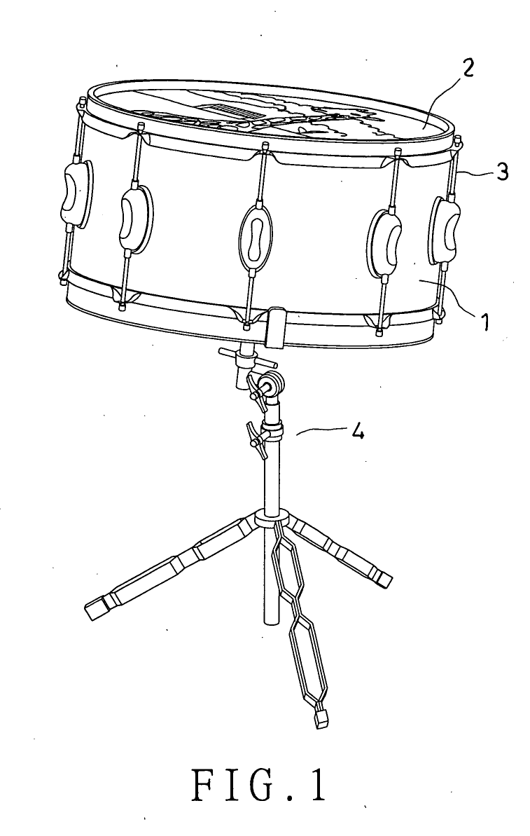

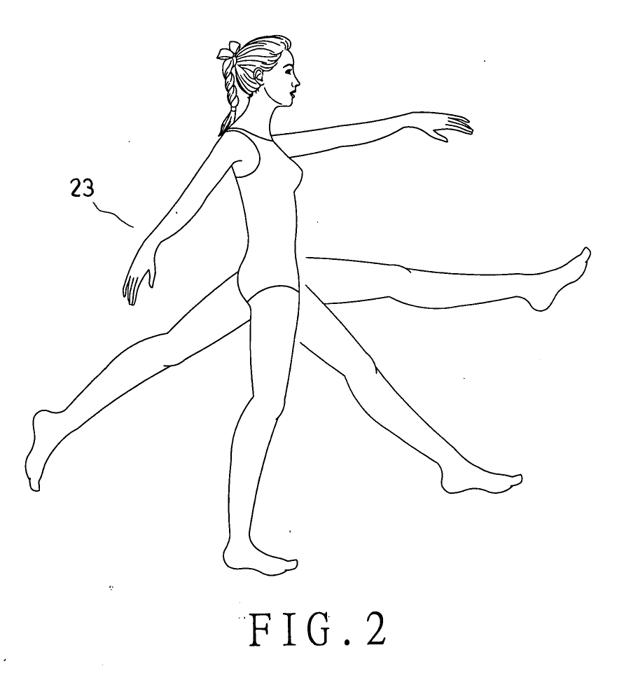

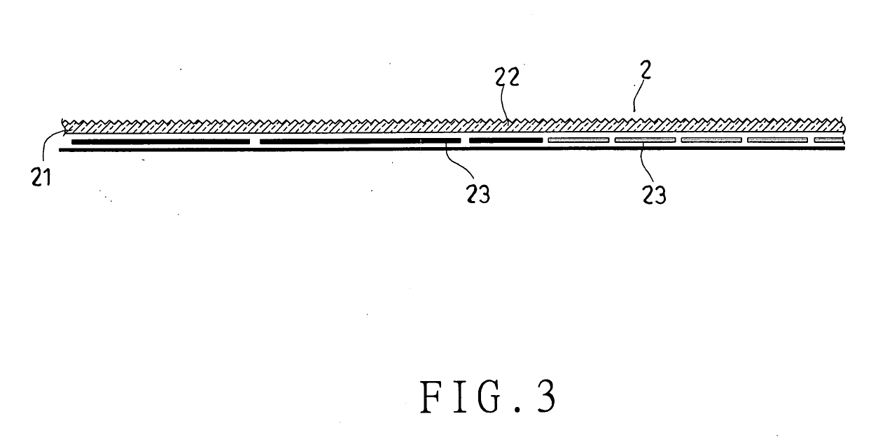

Referring to FIGS. 1 to 3, a preferred embodiment of a method for making plane animated printed drawings on a drumhead includes the following steps:

forming grating furrows and veins on a drumhead; several grating furrows and veins 22 are formed on an upper surface of a base material 21 of a drumhead 2 by means of a furrow and vein forming roller, which base material 21 is made of a plastic material such as PET (Polyethylene Terephthalate); the drumhead 2 is secured over one of upper and lower ends of a hollow rum body 1, which can be made of wood or metal; several tension rods 3 are positioned around the drum body 1 for adjusting tension of the drumhead 2; a stand 4 is positioned under and connected to the drum body 1 to support the drum body 1; and

printing continuous drawings on the drumhead; continuous drawings are printed on a lower surface of the base material 21 of the drumhead 2 by means of plane printing with a mesh-printing machine such that a layer 23 with printed continuous drawings is formed on the lower surface of the base material 21 of the drumhead 2; the drawings are photographed onto a negative film, and formed on a mesh plate before they are printed on the lower surface of the base material 21 by means of plane printing with the mesh-printing machine; the printed continuous drawings are single-layer ones.

Therefore, the base material 21 of the drumhead 2 has the layer 23 with printed single-layer continuous drawings on the lower surface thereof, and it has the grating furrows and veins 22 on the upper surface thereof, which are provided to refract light. When the drumhead 2 is hit and vibrating, the grating furrows and veins 22 will refract light such that the continuous printed drawings on the lower surface of the drumhead 2 show on the drumhead 2 in an animated manner.

From the above description, it can be easily seen that the drumhead of the present invention is more attractive than common ones because when it is hit and vibrating, continuous printed drawings will show thereon in an animated manner.

What is claimed is:

1. A method for making plane animated printed drawings on a drumhead, comprising steps:
forming grating furrows and veins on a drumhead; a plurality of grating furrows and veins being formed on an upper surface of a base material of a drumhead, which base material is made of a plastic material; said drumhead being secured over an upper end of a hollow rum body; and
printing continuous drawings on said drumhead; continuous drawings being printed on a lower surface of said base material of said drumhead by means of plane printing such that a layer with printed continuous drawings is formed on said lower surface of said base material.

2. The method for making plane animated printed drawings on a drumhead as recited in claim 1, wherein said hollow rum body is made of wood.

3. The method for making plane animated printed drawings on a drumhead as recited in claim 1, wherein said hollow rum body is made of metal.

4. The method for making plane animated printed drawings on a drumhead as recited in claim 1, wherein said hollow rum body has a drumhead secured over a lower end thereof.

5. The method for making plane animated printed drawings on a drumhead as recited in claim 1, wherein a plurality of tension rods are positioned around said drum body for adjusting tension of said drumhead.

6. The method for making plane animated printed drawings on a drumhead as recited in claim 1, wherein a stand is positioned under said drum body for supporting said drum body.

7. The method for making plane animated printed drawings on a drumhead as recited in claim 1, wherein said base material of said drumhead is made of Polyethylene Terephthalate.

8. The method for making plane animated printed drawings on a drumhead as recited in claim 1, wherein said grating furrows and veins are formed by means of a furrow and vein forming roller.

9. The method for making plane animated printed drawings on a drumhead as recited in claim 1, wherein said drawings are photographed onto a negative film before they are printed on said lower surface of said base material by means of plane printing with said mesh-printing machine.
